(19) United States
(12) Patent Application Publication
(10) Pub. No.: US 2016/0107618 A1
(43) Pub. Date: Apr. 21, 2016

(54) Pressure Checking and/or Adjustment Method and Device for a Tire-Wheel Assembly

(71) Applicants: COMPAGNIE GENERALE DES ETABLISSEMENTS MICHELIN, Clermont-Ferrand (FR); Michelin Recherche et Technique S.A., Granges-Paccot (CH)

(72) Inventors: Luc BESTGEN, Clermont-Ferrand Cedex 9 (FR); Rudy MEGEVAND, Clermont-Ferrand Cedex 9 (FR)

(21) Appl. No.: 14/977,038

(22) Filed: Dec. 21, 2015

Related U.S. Application Data
(62) Division of application No. 13/811,640, filed on Mar. 14, 2013.

(30) Foreign Application Priority Data
Jul. 21, 2010 (FR) 1055924

(51) Int. Cl. B60S 5/04; B60C 23/02

(52) U.S. Cl. CPC B60S 5/04; B60C 23/02

(57) ABSTRACT

A method for simplifying the conventional pressure monitoring and/or adjustment method for a mounted assembly for a vehicle, in particular for a two-wheeled vehicle, and, more precisely, reducing the number of steps in the method, and a pressure monitoring and/or adjustment device for the use of this method. A mounted assembly has a tire, preferably tubeless, mounted on a rim and inflated to an initial pressure, the tire having an inner surface forming the wall of the tire cavity, in contact with the internal air, the wall of the tire cavity being at least partially covered with a self-sealing material. An inflation interface is introduced into the tire cavity by piercing a hole in the wall of the tire cavity in an area covered by the self-sealing material, the inflation interface is extracted from the tire cavity after inflation, and the pierced hole in the wall of the tire cavity is sealed spontaneously by the self-sealing material, after the extraction of the inflation interface.

### RELATED APPLICATIONS

This application is a Divisional of U.S. application Ser. No. 13/811,640 filed Jan. 22, 2013 which is a U.S. National Stage Application under 35 USC §371 of International application No. PCT/EP2011/061915, filed Jul. 13, 2011, which claims priority of French application no. 10/55924 filed Jul. 21, 2010, the entire contents of all of which are hereby incorporated by reference.

### FIELD OF THE INVENTION

The invention relates to a method and a device for monitoring and/or adjusting the pressure of a mounted assembly, composed of an inflated tire mounted on a rim, for a vehicle.

Although it is not limited to this application, the invention will be described more particularly with reference to a mounted assembly for a two-wheeled vehicle of the bicycle type, and, even more particularly, with reference to a “tubeless” mounted assembly, comprising a tire which is “tubeless”, that is to say without an inner tube.

### BACKGROUND OF THE INVENTION

The development of the use of the bicycle as an individual means of transport in urban environments has led to the emergence of facilities for hiring bicycles on a self-service basis, particularly in the major cities. Hire businesses make bicycles available to users in special parking areas distributed in various districts of the city. A user wishing to travel from a point A to a point B can thus take possession of a bicycle at the nearest parking area to point A and return it to the parking area in the proximity of point B. This hire takes place on a self-service basis, that is to say the user takes possession of the bicycle and returns it independently, without any intermediary, as a result of the provision of devices such as parking terminals.

Because of the variety and large number of uses, a self-service bicycle hire service of this type requires a maintenance service which will ensure that the hired vehicles are in good working order. This maintenance is carried out either reactively, by repairing damage to the bicycle, or in advance, on a preventive basis, to limit the risk of damage.

Tires are an important factor in bicycle maintenance. The reactive maintenance of a tire essentially comprises the repair of a tire after a puncture. Advance, or preventive, maintenance of a tire essentially comprises monitoring and adjustment of the internal pressure of the tire. In the following text, the term “pressure” will be used to signify “internal pressure of the tire”.

For a puncture of a “tube type” tire, that is to say a tire with an inner tube, the reactive maintenance of the tire consists in blocking the hole or holes found in the inner tube, using adhesive patches.

In order to limit the risk of puncture, a bicycle tire for use in a self-service hire service is advantageously a “tubeless” tire, that is to say a tire without an inner tube located inside it. The absence of the inner tube limits the risk of loss of pressure due to damage caused by the piercing of the inner tube, and therefore obviates the repair of the inner tube, which is a time-consuming reactive maintenance operation.

If a puncture occurs in a tubeless tire, the conventional repair method is to place a sealing patch on the puncture hole in the tire. As an alternative solution, self-sealing devices have been proposed, such as self-sealing polymer materials, placed on all or part of the wall of the inner cavity of the tire during the manufacture of the tire, as described, for example, in the documents “Tire with self-closing layer” (WO2009/000742 A1) and “Method for applying a layer of material inside a cycle tire” (WO2009/000744 A1). These self-sealing polymer materials fill the puncture hole automatically as soon as the piercing occurs, without the need for external human intervention, thus eliminating a reactive maintenance operation.

As regards preventive maintenance, where the risk of puncture is concerned, the monitoring of the pressure, and its adjustment, where necessary, to a level at least equal to a rated pressure, is an essential operation.

The rated pressure is a recommended working pressure, and is, for example, between 3 and 4 bar for a tire for urban use. In practice, the rated pressure is not always maintained, either because of accidental leaks between the tire and its mounting rim or at the inflation valve, or, for example, because of a voluntary deflation of the tire by the user with the aim of obtaining greater comfort when travelling: consequently there is a need for pressure adjustment. If the actual measured pressure is significantly lower than the rated pressure, for example less than at least 0.75 bar, there is a risk that the tire may be punctured by an impact of the tire on an obstacle, causing the tire to be pinched against the rim flange and punctured.

The conventional method of pressure monitoring and/or adjustment normally uses a pressure monitoring and/or adjustment device which serves, on the one hand, to monitor the pressure, and, on the other hand, to adjust the pressure by inflation or deflation. This pressure monitoring and/or adjustment device comprises an inflation nozzle, designed for connection to an inflation valve fixed to the rim of the mounted assembly, and providing an interface with the internal air of the tire. The pressure monitoring and/or adjustment device further comprises a pressure measurement means such as a pressure gauge, and a means of adjusting the pressure by inflation and/or deflation, such as a compressor connected to an air reservoir.

The main steps in a conventional method for pressure monitoring and/or adjustment are as follows:

The mounted assembly is rotated about its axis of rotation, so as to provide access to the inflation valve fixed to the rim of the mounted assembly.

The protective cap of the inflation valve is unscrewed.

The inflation nozzle of the pressure monitoring and/or adjustment device is placed on the inflation valve.

The initial pressure is measured by the measuring means, such as a pressure gauge, of the pressure monitoring and/or adjustment device.

If the initial measured pressure is below the rated pressure, the tire is inflated to a final pressure level at least equal to the rated pressure.

The inflation nozzle of the pressure monitoring and/or adjustment device is withdrawn from the inflation valve.

The protective cap of the inflation valve is screwed back on.

The pressure monitoring and/or adjustment method described above has a number of drawbacks. In the first place, the number of steps in the pressure adjustment method requires an intervention time which has adverse effects on the use of a self-service bicycle fleet. Furthermore, it may be difficult to access the inflation valve which is fixed to the rim: it may be necessary to remove the bicycle from its parking terminal in order to be able to rotate the mounted assembly about its axis of rotation so as to provide access to the inflation valve. Finally, regardless of whether a pressure adjustment is or is not required, the intervention time for any given mounted assembly is substantially the same, because in both cases it is necessary to execute all the steps of the pressure adjustment method, except the inflation step, which form the major part of the intervention time.

### SUMMARY OF THE INVENTION

One object of the invention is to simplify the conventional pressure monitoring and/or adjustment method for a mounted assembly for a vehicle, in particular for a two-wheeled vehicle, and, more precisely, of reducing the number of steps in the method and proposing a pressure monitoring and/or adjustment device for the use of this method.

This aim is achieved, according to one aspect of the invention, by a method for monitoring and/or adjusting the pressure of a mounted assembly for a vehicle, the mounted assembly being composed of a tire, preferably tubeless, mounted on a rim and inflated to an initial pressure, the tire comprising an inner surface forming the wall of the tire cavity, in contact with the internal air, the wall of the tire cavity being at least partially covered with a self-sealing material in the following manner:

by introducing an inflation interface into the tire cavity by piercing a hole in the wall of the tire cavity in an area covered by the self-sealing material, and

by extracting the inflation interface from the tire cavity after inflation,

the pierced hole in the wall of the tire cavity being sealed spontaneously by the self-sealing material after the extraction of the inflation interface.

The term “initial pressure” signifies the tire inflation pressure measured during the initial pressure monitoring operation, at the start of the maintenance.

According to an embodiment of the invention, an inflation interface is introduced into the tire cavity by piercing a hole in the wall of the tire cavity in an area covered by the self-sealing material.

The inflation interface is the member of the inflation means of the pressure monitoring and/or adjustment device which directs the inflation air into the tire cavity. In a conventional pressure monitoring and/or adjustment device, the inflation interface is formed by an inflation nozzle designed to be connected to the inflation valve which itself is generally fixed to the rim of the mounted assembly. According to the invention, the inflation interface is introduced into the tire cavity through a hole made by piercing through the tire wall from one side to the other. The main advantage of this solution is that direct access is provided to the tire cavity without passage through the inflation valve, which may be difficult to access because of its position on the mounted assembly of the parked vehicle, or may not be present at all in the case of a valveless rim. A valveless rim is particularly suitable for use with a mounted assembly of a hire bicycle, in order to prevent any undesired modification of the pressure by the user.

The term “self-sealing material” signifies a material which at least partially covers the wall of the tire cavity and can spontaneously seal, without human intervention, a hole of “reasonable” size made in the wall of the tire. “Reasonable” size indicates a hole resulting from the piercing of the tire by an object commonly encountered on an urban road, such as a nail, a piece of glass, or the like. The wall of the tire cavity is partially covered with a self-sealing material; that is to say, it is covered in the areas where punctures are most likely to occur, such as the crown or the sidewalls of the tire. It is also possible for the wall of the tire cavity to be entirely covered by a layer of self-sealing material, with areas of excess thickness, if required, where punctures are more likely to occur. The self-sealing material is generally placed on the wall of the tire cavity during the manufacture of the tire. The presence of self-sealing material on part of the cavity wall of a given tire can be indicated by a marking element positioned on the outer surface of the tire opposite the part of the tire cavity wall in question.

After inflation, the inflation interface is extracted from the tire cavity, causing the pierced hole to appear in the wall of the tire cavity.

The pierced hole in the wall of the tire cavity is then advantageously sealed spontaneously, that is to say without any manual sealing operation by a human operator, by the self-sealing material present in the vicinity of the hole. To ensure that the pierced hole is sealed, a sufficient quantity of self-sealing material must be present in the vicinity of the pierced hole. This can be achieved by indicating the preferred piercing area or areas on the outer surface of the tire, using a distinctive marking, for example.

In a first embodiment of the invention, the inflation interface is introduced into the tire cavity before the measurement of the initial pressure. In other words, the inflation interface is introduced in all cases and unconditionally at the start of the maintenance operation, without any preliminary pressure measurement, thereby saving time.

In this first embodiment, the pressure is adjusted to a final pressure which is at least equal to a rated pressure, by using the inflation interface connected to an inflation means supplying the inflation air. The term “rated pressure” signifies the recommended working pressure for a given use of the tire. In the case of a tire for a two-wheeled vehicle such as a bicycle for urban use, the recommended working pressure for a given use of the tire is, for example, between 3 and 4 bar. By contrast with the usual practice, the pressure adjustment is not carried out by the inflation valve, but by the inflation interface.

In a second embodiment of the invention, the inflation interface is introduced into the tire cavity after the measurement of the initial pressure, and if the measured initial pressure is below a warning pressure. In other words, the inflation interface is introduced in certain cases and conditionally, after a preliminary pressure measurement, thereby limiting the number of piercings to the strictly necessary level and reducing the risk of damage to the tire reinforcement that might be caused by a large number of piercings. The condition for the introduction of the inflation interface is that the initial measured pressure is less than the warning pressure. The term “warning pressure” signifies the minimum recommended pressure for a given use of the tire, below which there is a high risk of puncture by pinching on the rim flange. In the case of a tire for a two-wheeled vehicle such as a bicycle for urban use, the warning pressure can be considered to be equal to the rated pressure or recommended working pressure, minus 0.75 bar. For example, for a rated pressure of 4 bar, the warning pressure may be considered to be 3.25 bar.

In this second embodiment, as in the first embodiment, the pressure is adjusted to a final pressure which is at least equal to a rated pressure, by using the inflation interface connected to an inflation means supplying the inflation air.

The rated pressure is advantageously at least equal to the warning pressure increased by 0.75 bar, to ensure that the difference between the final pressure and the warning pressure is sufficient to compensate for the natural pressure loss of a tubeless tire which is not perfectly airtight. For example, the pressure loss of a tubeless tire can be between 0.5 bar and 1 bar per month. However, the rated pressure must not be too high, in order to avoid any problems of discomfort for the user due to excessive stiffness of the tire.

In a variant of the first or second embodiment, the pressure is measured, during the adjustment of the pressure, by a means of direct pressure measurement, connected to the inflation interface. A means of direct pressure measurement can be, for example, a pressure gauge.

In another variant of the second embodiment, the pressure is measured, during the adjustment of the pressure, by a means of indirect pressure measurement, without any contact with the internal air of the tire. A means of indirect pressure measurement which does not require any contact with the internal air of the tire is not connected to either the inflation valve or the inflation interface introduced into the wall of the tire cavity.

By making an indirect measurement of the pressure it is possible to avoid passage through the valve or the use of a pressure gauge, thereby limiting the number of operations including making the valve accessible by rotating the mounted assembly, screwing on and unscrewing the valve cap, and screwing and unscrewing the inflation nozzle on to the valve, and consequently reducing the intervention time. Another advantage is that the pressure of a valveless mounted assembly can be measured.

In particular, if an indirect measurement of the initial pressure is made, the tire does not have to be pierced in all cases for the purpose of introducing an inflation interface into the tire cavity to determine the initial pressure by means of a pressure gauge. If the initial measured pressure is greater than the warning pressure, no pressure adjustment is required. Consequently the inflation interface is not put in place by piercing the wall of the tire cavity.

In a preferred variant of the second embodiment, the pressure is measured indirectly by measuring the deformation of the tire, in a direction of flattening of the tire, at two points, of which one at least is located on the outer surface of the tire in contact with the atmospheric air, and by determining the pressure with the aid of a model developed previously, which relates deformation to pressure.

The tire is flattened by a flattening means comprising two interfaces applying the flattening force to the tire. In practice, these two interfaces are applied either at two points, one of which is located on each of the two sidewalls of the tire, or at two points, one of which is located on the crown of the tire while the other is located at the rim. The tire can be flattened by applied force or applied displacement.

When a flattening force is applied to the tire, the tire is deformed between the two points of application of the flattening force. The measured deformation is the relative variation of the distance between the two points of application of the flattening force. This deformation is correlated with the rigidity of the tire, which itself is a function of the pressure. By determining this deformation, therefore, the pressure level can be found by using a mathematical model and/or charts showing the pressure as a function of the deformation, developed on the basis of experimental measurements.

Thus the measurement of the deformation of the tire makes it possible to find the corresponding pressure by means of a relation between the pressure and the measured flattening. By way of example, this relation may be of the following type:

P=A*[Z/(LI−LF)^{1/B}], where

P is the measured pressure,

A and B are two constants depending on the tire and on the shape and surface area of the interfaces for the application of the flattening force,

Z is the tire flattening force,

LI is the initial distance between the flattening force application interfaces (in practice, the initial width or height of the tire, before flattening),

LF is the final distance between the flattening force application interfaces (in practice, the final width or height of the tire, after flattening).

When this relation is known, the means of indirect pressure measurement can be calibrated in relation to the warning and rated pressures, and the indirect pressure measurement can be fully automated if necessary.

In a first variant of the preferred embodiment of indirect pressure measurement by measurement of deformation, the tire is advantageously flattened between two points, one of which is located on the outer surface of each sidewall, these points being symmetrical about the equatorial plane. This first variant embodiment is advantageous in terms of convenience, because the means of indirect pressure measurement does not interfere with the wheel. In the case of a spoked bicycle wheel, the presence of the spokes of the wheel does not impede the placing of the means of indirect pressure measurement.

In a second variant of the preferred embodiment of indirect pressure measurement by measurement of deformation, the tire is flattened between two points, one of which is located on the outer surface of the crown while the other is located on the radially inner surface of the rim, these points being positioned in the equatorial plane. In this second variant embodiment, the flattening force application interface in contact with the rim is advantageously fixed during the application of the flattening.

The inflation interface is advantageously introduced into the tire cavity by piercing the crown of the tire, the corresponding part of the wall of the tire cavity being covered by the self-sealing material.

As regards the area in which the inflation interface is introduced by piercing, the inflation interface can be introduced either through the crown of the tire which is intended to contact the ground via the tread, or through the sidewalls which extend the crown on either side.

The choice of the area for introducing the inflation interface by piercing depends on the accessibility of the piercing area, the thickness of the tire in the piercing area, the thickness of the reinforcement which is, in particular, thicker at the crown, and the presence of a self-sealing material in the piercing area. It may also depend on the level of mechanical stress, particularly bending stress, in the reinforcement, and the number of piercings already made in the same piercing area during previous pressure monitoring operations, the aim being to avoid always piercing the tire in the same place.

Preferably, the inflation interface is introduced into the tire cavity by piercing the crown of the tire, because the corresponding part of the wall of the tire cavity is generally preferably covered by the self-sealing material to ensure the spontaneous sealing of any hole made accidentally in the crown during use. If piercing is carried out away from the crown, in a sidewall for example, some of the self-sealing mixture must be present in the piercing area, as well as in the crown area. Another consideration is that piercing the crown has less of a weakening effect on the carcass reinforcement, which is the reinforcement linking the two beads of the tire designed to provide contact with the rim, and which is subject to less mechanical stress in the crown than in the sidewalls.

A pressure monitoring and/or adjustment device, for the application of the pressure monitoring and/or adjustment method described above, is also proposed.

According to an embodiment the invention, the pressure monitoring and/or adjustment device comprises an inflation interface, intended to be introduced into the tire cavity by piercing a hole in the wall of the tire cavity in an area covered by the self-sealing material. The inflation interface advantageously allows direct access to the tire cavity without passage through the inflation valve, which may be difficult to access because of its position on the mounted assembly of the parked vehicle, or may not be present at all in the case of a valveless rim.

The inflation interface is advantageously a hollow tube with an outside diameter of not more than 4 mm, and preferably not more than 1.5 mm. The inflation interface resembles a needle and has the double function of piercing the wall of the tire cavity and inflating the tire. However, these two functions may be separated if a piercing means independent of the inflation interface is provided. Additionally, a limited diameter makes it possible to avoid the mechanical weakening of the reinforcement structure of the tire which would be caused by cutting an excessively high number of reinforcing elements, such as fabric cords, which form the reinforcement of the tire. Furthermore, a limited diameter creates a hole in the wall of the tire cavity which can easily be filled by the self-sealing material, whereas this becomes difficult above a certain diameter.

In an advantageous embodiment of the invention, the pressure monitoring and/or adjustment device comprises a means of direct pressure measurement, connected to the inflation interface, and/or a means of indirect pressure measurement, adapted to measure the inflation pressure without any contact with the internal air of the tire.

A pressure monitoring and/or adjustment device comprising only a means of direct pressure measurement, connected to the inflation interface, is preferably used for the first embodiment of the pressure monitoring and/or adjustment method, in which the inflation interface is introduced into the tire cavity before the initial pressure is measured. In this case, any pressure measurement made after the introduction of the inflation interface is carried out directly by means of the inflation interface.

A pressure monitoring and/or adjustment device comprising only a means of indirect pressure measurement is preferably used for the second embodiment of the pressure monitoring and/or adjustment method, in which the inflation interface is introduced into the tire cavity after the initial pressure has been measured and if the initial pressure is below the warning pressure. The initial pressure measurement and any pressure measurement made after the introduction of the inflation interface are carried out indirectly by the means of indirect pressure measurement.

A pressure monitoring and/or adjustment device comprising both a means of indirect pressure measurement and a means of direct pressure measurement connected to the inflation interface is preferably used for the second embodiment of the pressure monitoring and/or adjustment method, in which the inflation interface is introduced into the tire cavity after the initial pressure has been measured and if the initial pressure is below the warning pressure. In this case, the initial pressure measurement is made indirectly by the means of indirect pressure measurement. Any pressure measurement made after the introduction of the inflation interface can then be carried out either indirectly, by the means of indirect pressure measurement, or directly, by means of the inflation interface.

In a preferred embodiment of the invention, the pressure monitoring and/or adjustment device comprises a means of indirect pressure measurement by measurement of the deformation of the tire in a direction of flattening of the tire.

In a preferred embodiment of the invention, the means of indirect pressure measurement by measurement of the deformation of the tire in a direction of flattening of the tire comprises two interfaces for applying the flattening force to the tire, designed to come into contact with two points, at least one of which is located on the outer surface of the tire in contact with the atmospheric air. This means of measuring the deformation is easy to use: the mounted assembly simply has to be placed between two mechanical interfaces designed to apply the mechanical flattening stress which is either an applied force or an applied deformation.

In another preferred embodiment of the invention, the pressure monitoring and/or adjustment device comprises an inflation interface integrated with the at least one interface for applying the flattening force of the means of indirect pressure measurement, thereby advantageously allowing the means of indirect pressure measurement and the inflation interface to be positioned simultaneously, thus saving time and increasing convenience.

The application of a pressure monitoring and/or adjustment method as described above is more particularly useful for a two-wheeled vehicle, and, even more particularly, for a bicycle.

### BRIEF DESCRIPTION OF THE DRAWINGS

FIG. 1 shows a first embodiment of the invention.

FIG. 2 shows a first variant of a second embodiment of the invention.

FIG. 3 shows a second variant of a second embodiment of the invention.

FIG. 4 shows an example of the variation of the flattening (LF−LI) of a bicycle tire as a function of pressure.

### DETAILED DESCRIPTION OF THE DRAWINGS

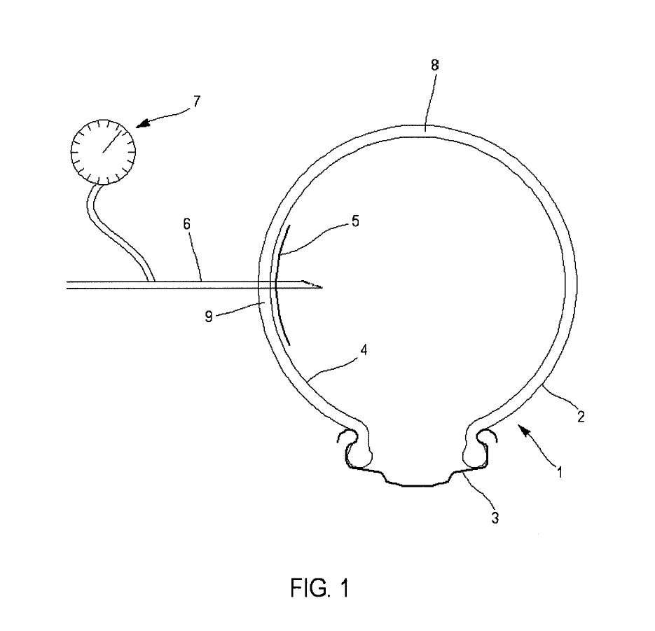

FIGS. 1 to 4 are not drawn to scale.

FIG. 1 shows a first embodiment of a pressure monitoring and/or adjustment device for a mounted assembly (1) for a bicycle. The mounted assembly is composed of a tubeless tire (2) mounted on a rim (3) and inflated to an initial pressure. The tire comprises an inner surface forming the wall (4) of the tire cavity in contact with the internal air. The wall of the tire cavity is covered by a self-sealing material (5) in the sidewall area (9), but not in the crown area (8). The pressure monitoring and/or adjustment device comprises a means of direct pressure measurement (7), of the pressure gauge type, connected to the inflation interface (6) which is of the hollow tube type.

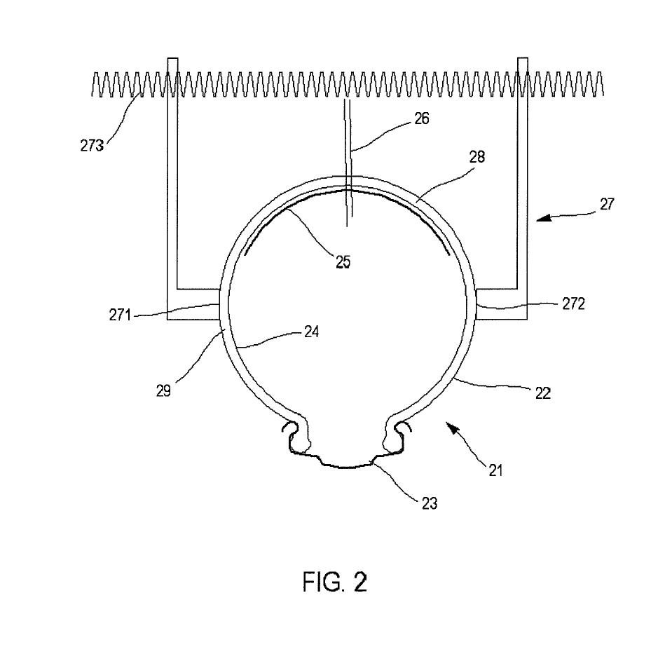

FIG. 2 shows a first variant of a second embodiment of a pressure monitoring and/or adjustment device for a mounted assembly (21) for a bicycle. The mounted assembly is composed of a tubeless tire (22) mounted on a rim (23) and inflated to an initial pressure. The tire comprises an inner surface forming the wall (24) of the tire cavity in contact with the internal air. The wall of the tire cavity is covered by a self-sealing material (25) in the crown area (28). The pressure monitoring and/or adjustment device comprises a means of indirect pressure measurement (27) by measurement of the deformation of the tire in a direction of flattening of the tire. The means of indirect pressure measurement (27) by measurement of the deformation comprises two interfaces for applying the flattening force to the tire, designed to come into contact with two points (271, 272), at least one of which is located on the outer surface of each sidewall (29), these points being symmetrical with respect to the equatorial plane of the tire, and also comprises a return spring (273). The pressure monitoring and/or adjustment device comprises an inflation interface (26) of the hollow tube type, which is introduced into the tire cavity by piercing a hole in the wall of the tire cavity in the crown area (28) which is covered by the self-sealing material (25).

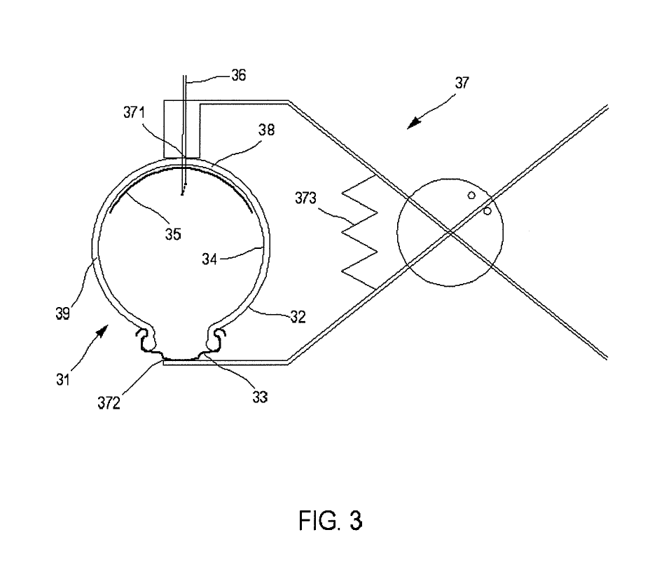

FIG. 3 shows a second variant of a second embodiment of a pressure monitoring and/or adjustment device for a mounted assembly (31) for a bicycle. The mounted assembly is composed of a tubeless tire (32) mounted on a rim (33) and inflated to an initial pressure. The tire comprises an inner surface forming the wall (34) of the tire cavity in contact with the internal air. The wall of the tire cavity is covered by a self-sealing material (35) in the crown area (38). The pressure monitoring and/or adjustment device comprises a means of indirect pressure measurement (37) by measurement of the deformation of the tire in a direction of flattening of the tire. The means of indirect pressure measurement (37) by measurement of the deformation comprises two interfaces for applying the flattening force to the tire, designed to come into contact with two points (371, 372), located, respectively, on the outer surface of the crown and on the radially inner surface of the rim, and positioned in the equatorial plane, and also comprises a return spring (373). The pressure monitoring and/or adjustment device comprises an inflation interface (36) of the hollow tube type, which is introduced into the tire cavity by piercing a hole in the wall of the tire cavity in the crown area (38) which is covered by the self-sealing material (35). The inflation interface (36) is integrated with the interface (371) for applying the flattening force of the means of indirect pressure measurement.

The invention has been more particularly developed for a tire for urban use with a size of 37/622, for which the recommended working pressure is 4 bar, leading to the choice of a warning pressure and a rated pressure equal to 3.25 bar and 4.5 bar respectively.

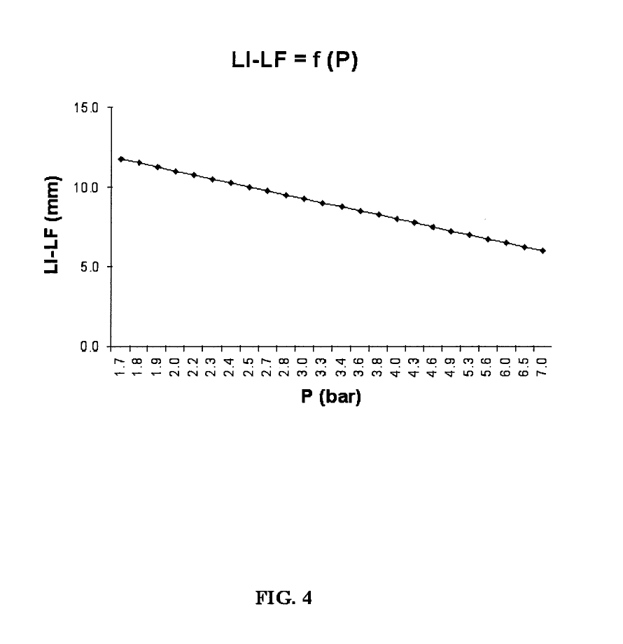

In the example under discussion, which corresponds to the embodiment shown in FIG. 3, an indirect pressure measurement, by measurement of the deformation of the tire, is made between the crown and the rim. The interface for applying the flattening force to the tire, designed to come into contact with the point (371) located on the outer surface of the crown, has a circular surface with a diameter of 6 mm. The return spring (373) has a stiffness of 10 N/mm. When the return spring is at rest, the distance between the two jaws, that is to say between two interfaces for applying the flattening force to the tire (371, 372), is 20 mm. The initial distance LI between the points of application of the flattening force is 49 mm. The final distance LF corresponding to the warning pressure of 3.25 bar, in the case of measurement of deformation with applied force, is equal to 40.1 mm. The final distance LF corresponding to the rated pressure of 4.5 bar, in the case of measurement of deformation with applied force, is equal to 41.4 mm. FIG. 4 shows the variation of the flattening (LF−LI) of a bicycle tire as a function of the pressure P.

The invention is not to be interpreted as being limited to the examples shown in FIGS. 1 to 3, but can be extended to other variant embodiments.

The invention, which has been described more particularly with reference to a mounted assembly composed of a preferably tubeless tire, is equally applicable to a tire of the tube type, that is to say one with an independent inner tube, provided that said inner tube is able to reseal itself independently, after piercing, with the aid of a self-sealing mixture or any other equivalent means.

The invention, which has been described more particularly with reference to a mounted assembly for a two-wheeled vehicle such as a bicycle, can be extended to a tire for a motorized two-wheeled vehicle, and, more generally, to a tire of any type of vehicle, with the adaptation of the warning and rated pressures.

What is claimed is:

1. A method for monitoring and/or adjusting the internal pressure of a mounted assembly for a vehicle, the mounted assembly having a tire mounted on a rim and inflated to an initial pressure, the tire having an inner surface forming a wall of a cavity of the tire, the wall of the cavity being in contact with internal air of the tire, the wall of the tire cavity being at least partially covered with a self-sealing material, the method comprising:
indirectly measuring the internal pressure without contact with internal air of the tire;
comparing the measured internal pressure with a rated pressure for the tire; and
if the indirectly measured internal pressure does not equal a rated pressure for the tire:
introducing an inflation interface into the tire cavity by piercing a hole in the wall of the tire cavity in an area covered by the self-sealing material,
adjusting, by the inflation interface, the pressure of the tire to a final pressure at least equal to the rated pressure, and
extracting the inflation interface from the tire cavity after the adjusting,
wherein the pierced hole in the wall of the tire cavity is sealed spontaneously by the self-sealing material after the extraction of the inflation interface.

2. The method of claim 1, wherein the tire is a tubeless tire.

3. The method of claim 1, wherein the inflation interface is introduced into the tire cavity after the indirect pressure measurement if the indirectly measured pressure is below a warning pressure, and wherein the pressure is adjusted to a final pressure, which is at least equal to the rated pressure, by the inflation interface.

4. The method of claim 3, wherein the rated pressure is at least equal to the warning pressure increased by 0.75 bar.

5. The method of claim 1, wherein the internal pressure is measured indirectly by measuring the deformation of the tire, in a direction of flattening of the tire, at two points, of which one at least is located on the outer surface of the tire in contact with the atmospheric air, and by determining the internal pressure using a model developed previously, which relates deformation to pressure.

6. The method of claim 5, the tire comprising a crown extended by two sidewalls and being symmetrical with respect to an equatorial plane passing through the center of the crown, wherein the tire is flattened between two points, one of which is located on the outer surface of each sidewall, the points being symmetrical with respect to the equatorial plane.

7. The method of claim 5, the tire comprising a crown extended by two sidewalls and being symmetrical with respect to an equatorial plane passing through the center of the crown, wherein the tire is flattened between two points, located, respectively, on the outer surface of the crown and on the radially inner surface of the rim, and positioned in the equatorial plane.

8. The method of claim 1, the tire comprising a crown extended by two sidewalls and being symmetrical with respect to an equatorial plane passing through the center of the crown, wherein the inflation interface is introduced into the tire cavity by piercing the crown of the tire, the corresponding part of the wall of the tire cavity being covered by the self-sealing material.

9. A device for monitoring and/or adjusting the internal pressure of a mounted assembly for a vehicle, the mounted assembly being comprised of a tire mounted on a rim and inflated to an initial pressure, the tire comprising an inner surface forming the wall of the tire cavity, in contact with internal air of the tire, the wall of the tire cavity being at least partially covered with a self-sealing material, the device comprising:
an indirect tire pressure measuring device configured to indirectly measure inflation pressure without coming into contact with the internal air of the tire; and
an inflation interface configured to be introduced into the tire cavity by piercing a hole in the wall of the tire cavity in an area covered by the self-sealing material.

10. The device of claim 9, wherein the inflation interface is a hollow tube with an outside diameter of not more than 4 mm.

11. The device of claim 9, wherein the indirect tire pressure measurement device operates by measuring the deformation of the tire in a direction of flattening of the tire.

12. The device of claim 11, wherein the indirect tire pressure measurement device measures deformation in the direction of flattening of the tire comprises two interfaces for applying flattening to the tire, adapted to come into contact with two points, at least one of which is located on the outer surface of the tire in contact with the atmospheric air.

13. The device of claim 9, wherein the inflation interface is integrated with the at least one interface for applying the flattening force of the indirect tire pressure measurement device.

14. The device of claim 9, wherein the tire is a tubeless tire.

15. The device of claim 9, wherein the inflation interface is a hollow tube with an outside diameter of not more than 1.5 mm.
